(19) United States
(12) Patent Application Publication
(10) Pub. No.: US 2008/0312486 A1
(43) Pub. Date: Dec. 18, 2008

(54) Method for separation of hydrocarbon oils from a waxy feedstock and apparatus for implementation of said method

(75) Inventor: Anatoly Vishnevsky, Haifa (IL)

Correspondence Address: Lilling & Lilling PLLC, PO Box 435, Jerusalem, 91003, IL

(73) Assignee: YUTEC TECHNOLOGIES LTD., Haifa (IL)

(21) Appl. No.: 11/762,940

(22) Filed: Jun. 14, 2007

(51) Int. Cl. B01D 9/02

(52) U.S. Cl. 585/812; 422/254

(57) ABSTRACT

A method and apparatus for separation of hydrocarbon oil and wax from a hydrocarbon waxy feedstock is disclosed. Said method comprises cooling the feedstock by a cooling agent so as to induce crystallization of hard wax crystals containing some quantity of oil. The method comprises the steps of
providing a vessel defined by a tubular shell closed at its opposite ends by a front cover and by a rear cover, said vessel having a longitudinal central axis,
providing a plurality of hollow partitions dividing said vessel into plurality of compartments, each of said partitions having an inlet port for introducing the cooling agent thereinto and an outlet port for evacuating the cooling agent therefrom,
providing a plurality of branch pipes having bridging portions, which allow flow communication between adjacent partitions such that the inlet port of a one hollow partition is in fluid communication with the outlet port of an adjacent hollow partition,
providing a flow of the feedstock mixture along the vessel in a direction from the forward port to the rear port,
providing a flow of the cooling agent through said plurality of hollow partitions in a counter-current direction, said method further comprises orientation of said vessel horizontally and deployment of said branch pipes outside the vessel and at the same side from the longitudinal axis.

The invention allows increasing the hard wax yield and at the same time to simplify the whole process since the slack wax cooling and hard wax crystallization could be carried out without preliminary dilution of said slack wax feedstock. Furthermore by virtue of the present invention there is no need to complete the crystallization in the double-pipe scraped-surface chiller, and the second stage of filtration can be excluded.

### FIELD OF THE INVENTION

The present invention relates mainly to petroleum processing, in particular to lubricant oil and wax production. The invention concerns separation of petroleum wax from oil by virtue of crystallization of wax from the waxy feedstock and subsequent filtering and evacuation of the solvent from the soft and hard wax mixture.

It should be borne in mind, however that the present invention is not limited strictly to the petroleum processing. The present invention can be used also in the food industry, in manufacturing of vegetable oils, in particular for their winterization when fractionizing of vegetable oils is carried out by crystallization of solid fats with their subsequent filtration.

### BACKGROUND OF THE INVENTION

There are known numerous publications describing separating of petroleum wax from hydrocarbon oils in a waxy feedstock. The processes employed for this purpose are based on crystallization of wax from the feedstock, which is a mixture of slack wax, solvent and oil.

An example of such a process can be found in U.S. Pat. No. 5,196,116 in which there is disclosed a process for solvent dewaxing of a waxy oil feed to obtain petroleum base oil. The process comprises the step of contacting of a warm waxy oil feed by indirect heat exchange first with the cold filtrate and then with the refrigerant to crystallize the wax in the oil feed to form an oil/solvent/wax mixture. The disadvantage of this method is associated with the fact that it is not suitable to separation of petroleum oils having low pour point.

Typical method of crystallization can be found in a book “Lubricant base oil and wax processing” p. 167-169, 1994 by Avelino Sequeira. According to this method the waxy feedstock is heated to 10-15 Degrees F. above the cloud point of the oil/wax/solvent mixture and is diluted with a solvent while chilling at a controlled rate in double-pipe scraped surface exchanger and chiller. The shortcoming of this method is low filtration rate of the slurry and low yield of dewaxed oil and hard wax. Furthermore, the crystallization method employing double-pipe scraped exchanger is inefficient since it requires often cleaning of clogged filtration surfaces. This, in its turn, requires high consumption of solvent and therefore its high losses and besides of all requires high consumption of energy.

Apart of the above-mentioned disadvantages the method of crystallization disclosed in the above book does not ensure full separation of oil occluded within dendrite structure of crystallized wax.

Strong competition in the field of petroleum processing as well as severe ecological requirements call upon permanent improvement of the processing of base oil and wax. An attempt to improve the crystallization technology based on the principle of double pipe scraped surface exchanger and chiller is described in U.S. Pat. No. 6,413,480. In this patent is disclosed an apparatus for separation of wax from a feedstock comprising a solvent, an oil component and a wax component. The apparatus comprises vertically oriented crystallization column, which interior is separated by hollow partitions into a plurality of compartments functioning as individual crystallization chambers. The feedstock flows through the column in one direction. The compartments are connected by zigzag tubular connections to allow the flow of cooling agent therethrough in the opposite direction. The wax crystals are formed on the outside surface of the partitions and there are provided also scraping means for scraping the wax crystals from the outside surface of the partitions.

By virtue of separation the column into individual crystallization chambers it is possible to organize the crystallization process at conditions, which are favorable for nucleation and formation of large wax crystals.

Unfortunately, the separation apparatus provided with vertically oriented column has several drawbacks. Its maintenance is complicate and very inconvenient. Replacement of scrapers requires dedicated auxiliary devices. In the lower and upper part of the column stagnation zones are formed, in which mixing is impossible and therefore crystallization becomes inefficient.

On the other hand the known in the art horizontally oriented double-pipe scraped-surface exchanger and chiller does not provide favorable conditions for nucleation and growth of wax crystals. The prior art references do not teach, suggest or motivate how to establish these conditions by virtue of separation the double-pipe exchanger into individual crystallization chambers.

Therefore despite existing numerous apparatuses for separation of hydrocarbon oils and wax there is nevertheless still felt a need in a new and improved apparatus and method for separation, which would combine advantages of the existing solutions, without however having their drawbacks.

### SUMMARY OF THE INVENTION

The main object of the present invention is to provide for a new and improved method of separation and an apparatus for its implementation, which will sufficiently reduce or overcome the above-mentioned drawbacks of the known-in-the-art methods and apparatuses.

The other object of the invention is to provide for a new and improved method and apparatus for separation of petroleum or vegetable oils from a waxy or fatty feedstocks by wax or fat crystallization in a horizontally directed vessel, which would be convenient in operation and maintenance, in which there would be no stagnation zones and efficient mixing of the feedstock would be possible along the entire length.

Still further object of the invention is to provide for a new and improved solution for separation of petroleum or vegetable oils from a waxy or fatty feedstock by a crystallization apparatus, which is divided into discrete crystallization compartments, in which crystallization can be carried out at the most favorable conditions and most efficiently.

Yet another object of the present invention is to provide for a new and improved solution for separation of petroleum oils from wax or vegetable oils from solid fat, which allows their separation with increased slurry filtration rate and with improved yield of petroleum dewaxed oil and hard wax or vegetable oil and solid fat.

For a better understanding of the present invention as well of its benefits and advantages, reference will now be made to the following description of its embodiments taken in combination with the accompanying drawings.

### BRIEF DESCRIPTION OF THE DRAWINGS

FIG. 1 depicts crystallization apparatus of the present invention and its interior.

FIG. 2 is a side view of the apparatus seen in FIG. 1, in which is schematically shown longitudinal serpentine flow path of the waxy feedstock.

FIGS. 3a and 3b are partial cross-sectional views, which respectively depict clearance gap between the disks and the shell and sealing arrangement therebetween.

FIG. 4a, 4b are partial cross-sectional views, which depict clearance gap between the disks and the shaft and sealing arrangement therebetween.

FIG. 5 is a partial cross-sectional view of the apparatus depicting how the cooling disks are affixed to the shell.

FIG. 6a is a partial view of the scraper arrangement.

FIG. 6b is a cross-section of FIG. 6a taken along A-A.

FIG. 7 shows mixing means.

FIG. 8 is a flow diagram of the prior art wax separation system (deoiling process).

FIG. 9 is a flow diagram of the wax separation system (deoiling process) of the present invention.

### DETAILED DESCRIPTION OF SPECIFIC EMBODIMENTS

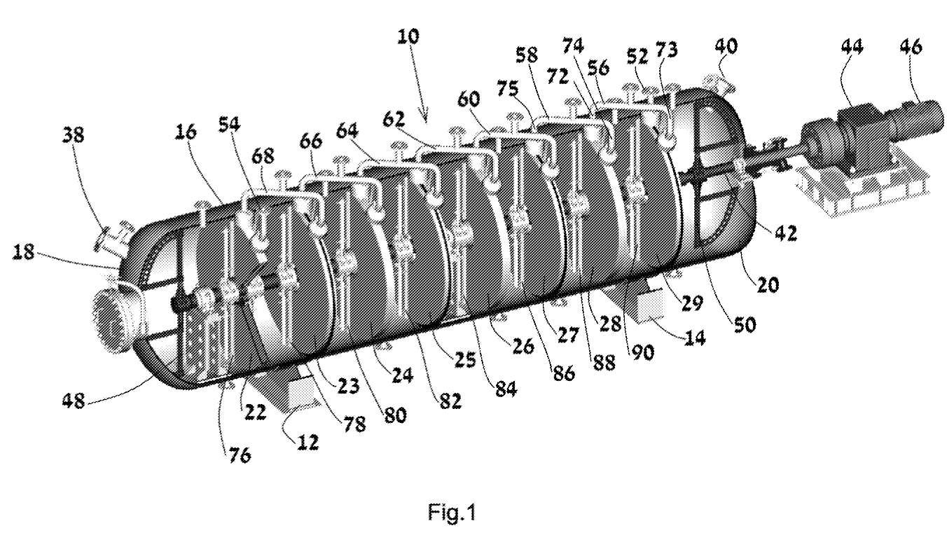

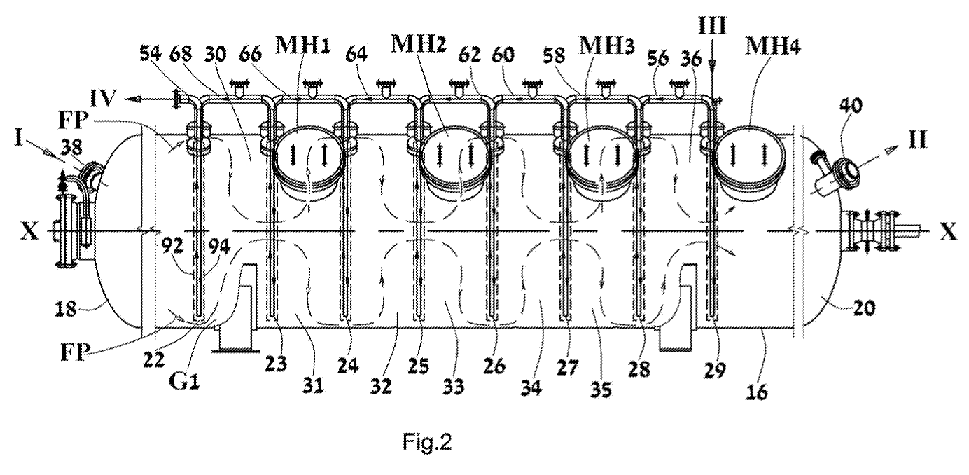

With reference to FIG. 1, 2 design of the apparatus of the invention will be explained. In the further description the apparatus for crystallization of wax from oil will be referred-to also as a crystallization apparatus. The crystallization apparatus is configured as an elongated tubular vessel 10, which is oriented horizontally and rests on legs 12, 14. The vessel is defined by an outside tubular, preferably cylindrical, shell 16, having longitudinal axis X-X. The vessel is closed at its opposite ends by a lateral forward cover 18 and by a lateral rear cover 20. Accordingly that region of the vessel, which is adjacent to the cover 18, will be referred-to further as a forward region and that region, which is adjacent to the cover 20, will be referred-to as a rear region. Within the vessel there are arranged hollow disk-like partitions, which divide the vessel's interior into a plurality of compartments. In FIG. 1 the disk-like partitions are designated by reference numerals 22, 23, 24, 25, 26, 27, 28, 29. For the sake of brevity in the further disclosure the disk-like partitions will be referred-to simply as disks. Disk 22, which is adjacent to the forward region, will be referred-to as forward disk and disk 29, which is adjacent to the rear region, will be referred-to as rear disk. In FIG. 1 the interior of the vessel is divided into compartments defined by even disks 22, 24, 26, 28 and four odd disks 23, 25, 27, 29. The disks divide the interior of the vessel into seven compartments defined between the adjacent disks. The compartments are designated in FIG. 2 by even reference numerals 30, 32, 34, 36 and by odd reference numbers 31, 33, 35. It should be borne in mind that the amount of disks and compartments not necessarily would be as in FIGS. 1, 2. The amount of disks and compartments depends on the overall length of the vessel and on its diameter, which, in its turn, is defined by the desired capacity of the crystallization apparatus.

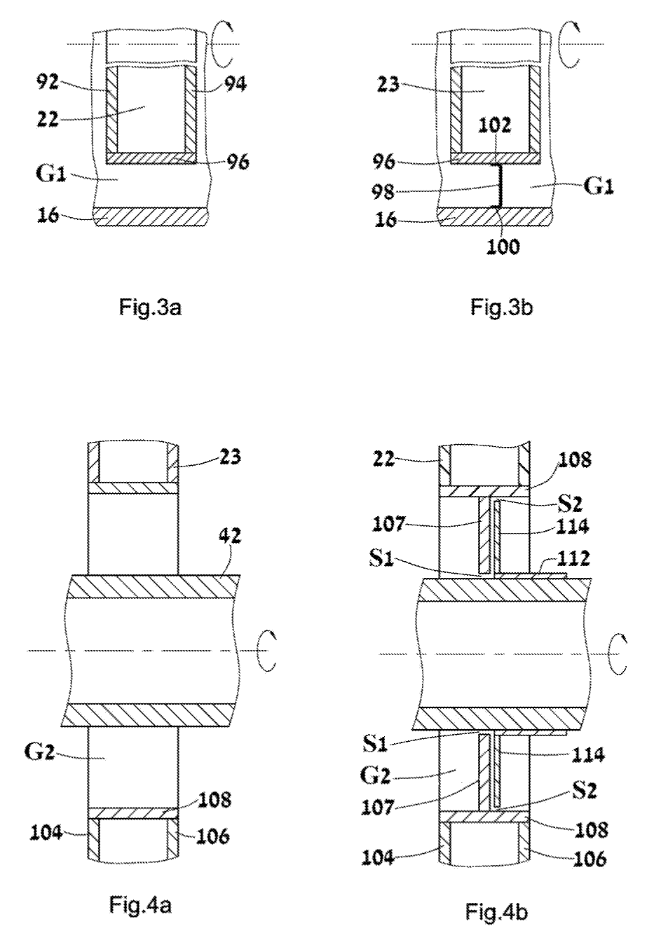

The outside diameter of the disks is less than the inside diameter of the shell such that a clearance gap G₁ is provided therebetween. This clearance gap is schematically shown in FIG. 2 and in more details in FIG. 3a. The gap is shown with regard to disk 22, but one should bear in mind that similar gap is provided for all disks.

In accordance with the invention at all even disks 22, 24, 26, 28 this gap is open, while at all odd disks 23, 25, 27 and 29 this gap is sealed by a sealing arrangement, which will be explained in more details with reference to FIG. 3b.

Shown in FIG. 2 appropriate manholes MH₁, MH₂, MH₃, and MH₄ are made in the shell. The manholes are distributed along the vessel length to enable direct access to interior of each compartment and disk and to the rear region of the vessel. Since the vessel is oriented horizontally the access is easy and maintenance of the vessel is convenient. The amount of manholes and their location along the vessel can vary and depend on which region of the vessel should be accessed.

The lateral covers are respectively provided with an inlet port 38 and an outlet port 40, through which a waxy feedstock in the form of slurry) is introduced into the vessel and is evacuated therefrom by appropriate pumping means (not shown). The feedstock consists essentially of a wax component and an oil component. The feedstock can contain also a solvent component. The non-limiting list of suitable solvents comprises acetone, methyl ethyl ketone, methyl isobutyl ketone, dichloroethane, methylenedichloride, propane, toluene, benzene, cyclohexane, monohydroxy alcohols or their mixtures.

As will be explained further the feedstock proceeds in the longitudinal direction from the forward region to the rear region of the vessel.

Extending along the longitudinal central axis of the vessel a shaft 42 is provided. The shaft is mounted on bearings (not shown). The shaft is rotatable by an external drive for example a gear 44 driven by a motor 46.

The shaft extends through the disks by virtue of a clearance gap G₂ provided between the shaft and the central region of the disks. The gap G₂ ensures that the disks remain steady when the shaft rotates. For the sake of brevity this gap is shown in FIG. 4a only for disk 23; however one should appreciate that similar gaps are provided between the shaft and the rest of disks. In accordance with the present invention at all odd disks 23, 25, 27, 29 this gap is open, while at all even discs 22, 24, 26, 28 this clearance gap is sealed by a sealing arrangement, which will be explained in more details with reference to FIG. 4b.

It will be explained further that since at the even disks gap the G₁ is open, while at the odd discs the gap G₂ is open the feed stock flows along the vessel in a serpentine fashion.

Again with reference to FIG. 1 it is shown that secured at the opposite ends of the shaft are mixers 48, 50. When the shaft rotates the mixers mix the feedstock at the forward region of the vessel and at the rear region of the vessel. By virtue of this provision stagnation of the feedstock in these regions is prevented.

The entrance of the feedstock into the vessel is designated in FIG. 2 by an arrow I. An arrow II designates the exit of the feedstock from the vessel. The flow path of the feedstock within the vessel is designated in FIG. 2 by arrow FP and it is seen that this path has a serpentine pattern, in the sense that while longitudinally flowing along the vessel from the forward region to the rear region, the feedstock periodically flows also from the vessel's periphery to its center and back. It is seen, for example that the feedstock first passes via clearance gap G₁ provided between the even disks 22, 24, 26, 28 and the shell, then it flows further from the vessel's periphery towards the shaft, then it passes the clearance gap G₂ between the adjacent odd disks 23, 25, 27, 29 and the shaft and after that it flows from the center of the vessel to its periphery. This pattern repeats such that the feedstock consequently passes the entire length of the vessel from its forward region to the rear region.

It will be explained further that to make this serpentine pattern possible, two types of sealing arrangements are provided. The sealing arrangement of the first type seals the gaps G₁ between the odd disks 23, 25, 27, 29 and the shell. The sealing arrangements of the second type seal the gap G₂ between the even discs 22, 24, 26, 28 and the shaft. By virtue of this provision transfer of the feedstock from one compartment to another is possible in a serpentine fashion. The movement of the feedstock in the serpentine pattern minimizes temperature and concentration gradients within the slurry volume that is preferable for the crystallization process.

Seen in FIG. 1 is an entrance port 52 for introducing the cooling agent into rear disk 29. Seen in FIG. 1 is an exit port 54 for exiting the cooling agent from the forward disk 22.

It is also shown that adjacent discs are connected therebetween by a plurality of branch pipes 56, 58, 60, 62, 64, 66, 68. Each branch pipe is provided with a bridging portion, with an outlet port connected to a one disk and with an inlet port connected to an adjacent disk. So, for example, bridging portion of the branch pipe 56 between disks 29 and 28 is connected to outlet port 73 of disk 29 and to inlet port 72 of the adjacent disk 28. The cooling agent enters into disc 29 through entrance port 52 flows to the branch pipe 56 via outlet port 73, then it proceeds through the bridging portion to the inlet port 72, through which it enters in the adjacent disk 28. The rest of the branch pipes is arranged in the similar fashion, i.e. the next branch pipe that is numbered 58 is connected to outlet port 74 of disk 28 and to inlet port 75 of the adjacent disk 27. By virtue of this connection the cooling agent is allowed to pass the entire length of the vessel while flowing successively from one disk to the adjacent disk such that the cooling agent can flow in the direction from rear disk 29 to forward disk 22. This direction is designated in FIG. 2 by arrows III and IV. It can be appreciated that this direction is counter-current to the direction of the feedstock flow designated by arrow I and II.

In accordance with the invention the branch pipes are situated outside of the vessel's interior and at the same side with respect to the longitudinal axis X-X. By virtue of this provision the branch pipes are easily accessible and therefore the apparatus assembling and maintenance is convenient.

The cooling agent is driven from one disk to another by appropriate pumping means, which is not shown. As suitable cooling agent one can use filtrate obtained during separation of the slurry by filters, or water.

Secured on the shaft are scraper arrangements 76, 78, 80, 82, 84, 86, 88, 90, which are provided with scrapers situated in close proximity to respective discs 22, 23, 24, 25, 26, 27, 28, 29. When the shaft rotates, the scrapers scrape the wax crystals formed on the disc's surfaces and mix the slurry.

The main factor for efficient separation of oils from waxes is the initial stage of wax crystallization, i.e. the nucleation, when micro wax nuclei are formed, which then grow into large crystals. The nucleation conditions determine the amount of the obtained wax crystals, their quality in terms of their size and shape, and the amount of occluded oil.

The present invention seeks to provide crystallization apparatus and method for separation of oils from waxes, which establishes the most favorable conditions for nucleation and subsequent growth of large and homogeneous crystals. In accordance with the invention this is achieved by virtue of two measures: arranging the feedstock flow path in the serpentine fashion as described above and maintaining an empirical relationship between the cooling area and the volume of the waxy feedstock present in each compartment.

When the feedstock flows in the serpentine fashion from one compartment to another it is cooled by the cooling agent flowing in the counter-current direction from one disk to another. The serpentine flow path and the slurry mixing assists(s) to formation of the wax crystals both on the disk's surfaces and within the volume of the feedstock.

In accordance with the invention it is advantageous to maintain an empirical relationship between the cooling area and the volume of the feedstock. This empirical relationship satisfies the expression α=S/V, where S is the cooling area in square meters, V is the volume of waxy feedstock to be cooled in cubic meters and α is a parameter. It has been empirically revealed that the most favorable conditions for crystallization can be established if the above parameter is 4-7 m⁻¹.

Accordingly one should divide the vessel by the plurality of disks in such a manner that the volume of the feedstock in each compartment and the cooling area of each compartment would satisfy the above expression.

Thus the conditions are achieved required for obtaining large wax crystal, which grows essentially in the volume of the feedstock at conditions of low supersaturation.

Besides, it has been found that by virtue of the above provisions it is possible to double or even to triple the over-all heat transfer coefficient in this apparatus comparing with double-pipe scraped-surface exchanger.

Now with reference to FIG. 3b an example of the sealing arrangement of the first type, namely between the disk and the shell will be explained. Since this exemplary arrangement is similar for the odd disks it will be described only with regard to disk 23. It is seen that hollow interior of disk 23 is defined between two planar sidewalls 92, 94 (FIG. 3a) and an external annular wall 96. Clearance gap G₁ between the external annular disk's wall and shell 16 is sealed by a Π-shaped partition, which is provided with a vertical portion 98 and horizontal shelf portions 100, 102. The shelf portions are respectively affixed to the shell and to the annular disk's wall. In practice the π-shaped partition is made from metallic material and it can be affixed to the disks by welding or by screw. The thickness of the partition is selected in such a manner that vertical portion 98 would be elastically deformable being affected by temperature variation during operation of the crystallization apparatus. By virtue of this provision the clearance gap between the disk and the shell will be always reliably sealed.

Now with reference to FIG. 4b an example of the sealing arrangement of the second type, namely between the shaft and the discs will be explained. Since this exemplary arrangement is similar for the even disks it will be described only with regard to disk 22. It is seen that hollow interior of disk 22 is defined by two planar sidewalls 104, 106 and by an annular inner wall 108. The inner wall defines gap G₂ through which shaft 42 passes. Protruding from the inner annular wall towards the shaft a flat partition 107 is provided. The partition protrudes in such extent that a small space S₁ of at least several millimeters is left between the partition and the shaft.

A bushing is rigidly secured on the shaft. The bushing is provided with a tubular neck portion 112, which is affixed to the shaft and with a flange portion 114, which is perpendicular to the neck portion. Flange portion 114 is located in close proximity to flat partition 107 and is separated therefrom by a narrow space of at least several millimeters.

Diameter of the flange portion is less than diameter of gap G₂ such that a small space S₂ of at least several millimeters is provided between flange portion 114 and annular inner wall 108.

Since a very narrow space is left between the flat partition and the flange portion the feedstock is in fact prevented from flowing between the shaft and the disks and therefore it flows essentially between the annular external disk's wall and the shell. At the same time free rotation of the shaft with respect to the disk is allowed.

It should be borne in mind, that the above-described sealing arrangements are only an example. For sealing the disks from the shell and from the rotating shaft one could use any other suitable sealing arrangement, which is know in the art.

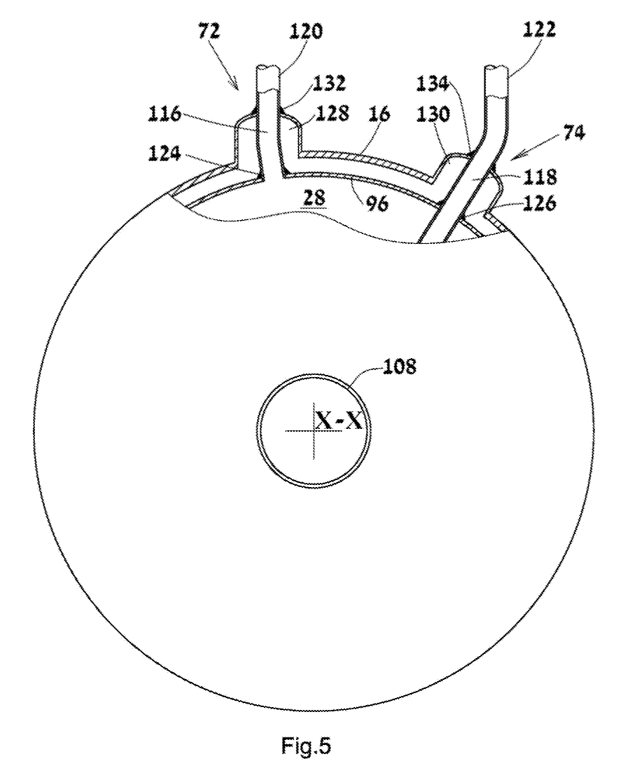

Referring now to FIG. 5 it will be explained how external annular walls of the disks are affixed to the shell. The explanation refers to disc 28. It should be borne in mind that similar explanation is applicable to the rest of disks.

Interior of disc 28 is defined by external annular wall 96 and inner annular wall 108. Disc 28 is provided with inlet port 72 and with outlet port 74 having respective tubular portions 116, 118 and end portions 120, 122. Tubular portions are welded to the external annular wall of the disk at respective locations 124, 126 at one side of the longitudinal axis X-X.

Disc 28 is deployed within shell 16, which is provided with caps 128, 130, situated at the upper side of the shell. Tubular portions 116, 118 pass through respective caps and are welded to the caps at respective locations 132, 134 such that the end portions and respective tubular bridging portions remain outside the shell being above the caps and at one side of the longitudinal axis X-X. By virtue of this provision the branch pipe can be conveniently accessed, which renders the maintenance easy.

Furthermore, since tubular portions of the inlet and outlet ports are welded to the disks and to the caps at the same side with respect to axis X-X the disks hang on the shell. By virtue of this provision there is no danger for thermal stress formation during operation of the apparatus.

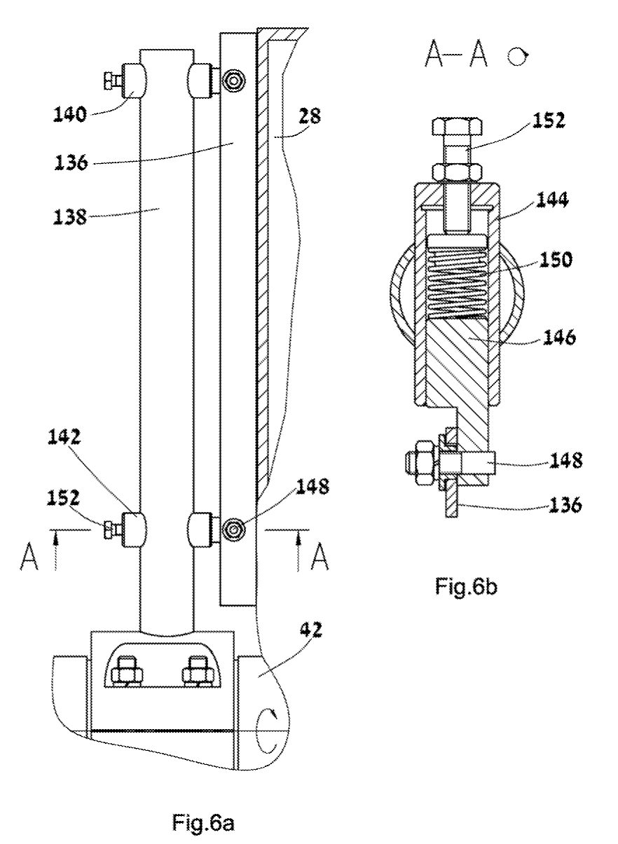

Referring now to FIG. 6 the scraper arrangements will be explained.

The further explanation refers to disc 28 provided with scraper arrangement 88. Similar explanation refers to the rest of discs.

In accordance with the invention the scraper arrangement comprises elongate scraping blade 136 affixed to supporting rod 138 by at least two fastening assemblies 140, 142. Each fastening assembly comprises a cup member 144 and a pusher 146 displaceable along the cup member perpendicularly to the supporting rod. Supporting rod 138 is rigidly secured on shaft 42.

The pusher is connected to the scraping blade by a fastening screw 148. A biasing spring 150 is provided in the cup member. The spring is located between butt end of the cup member and the pusher and it is biased to exert force on the pusher and thus to push the scraping blade towards the disk. An adjusting bolt 152 is provided for controlling the pushing force and thus for adjusting the distance between the scraping blade and the disk. By virtue of the biasing spring the scraper blade is pressed to the disk while being allowed to “float” above the disk surface when it scrapes crystals formed thereon.

In practice it is especially advantageous in terms of desired over-all heat transfer coefficient and of the crystals growth if the scraper arrangements are rotated (by the shaft) with peripheral linear velocity in the range of 0.3-1.5 m/sec.

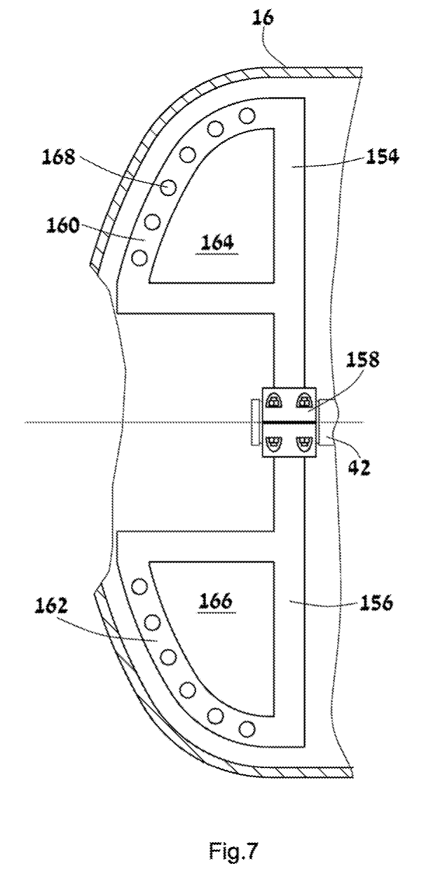

Now referring to FIG. 7 construction of mixers 48, 50 will be described. Despite the further description refers merely to mixer 48 it is applicable to mixer 50 as well.

Mixer 48 is of the anchor type and it is configured as an impeller comprising two symmetrical paddles 154, 156 rigidly secured on shaft 42 by a collar 158. Each paddle is provided with respective mixing blades 160, 162. The curvature of blades 154,156 follows the contour of the shell 16 such that a minimal clearance is provided between the mixing blades and the inwardly facing surface of the shell. It is advantageous if the wings are provided with windows 164, 166 and the mixing blades have perforations 168. By virtue of this provision it is possible to efficiently mix even relatively viscous feedstock.

It is not shown specifically but should be understood that the apparatus is also equipped with appropriate instrumentation for measuring and controlling of various parameters of the process, e.g. temperatures, flows rate, pressure drops, shaft rotation rate, etc.

It has been revealed that by virtue of the new crystallization apparatus of the present invention it is possible to sufficiently improve the process of separation, irrespective whether the separation is carried out during the process of dewaxing of oils or the process of slack wax deoiling. Due to formation of large and homogeneous wax crystals there are achieved many advantages, like for example increase of the slurry filtration rate, reducing of the filter cloth clogging, increase of the time of filtering operation without hot washing of filter cloths, reducing of solvent/feedstock dilution ratio, increase of dewaxed oil and hard wax yield, reducing of the solvent losses.

Since the pressure drop of the slurry flow in the new crystallizer is negligible (10-20 mm H₂0), the slack wax deoiling can be carried out without preliminary dilution of the feedstock by solvent. This renders the wax deoiling process simpler and more effective.

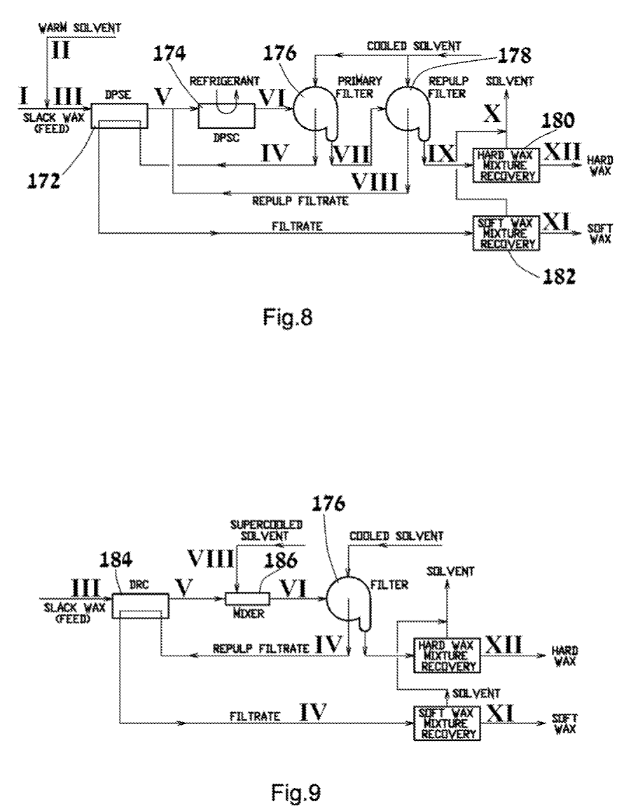

With reference to FIG. 8 it is shown flow diagram of a conventional slack wax deoiling process using double-pipe scraped-surface exchanger (DPSE) and double-pipe scraped-surface chiller (DPSC).

The various flows participating in the process are designated by Roman numerals and the various items of the equipment used for implementation of the separation process are designated by Arabic numerals. As seen in FIG. 8 to a slack wax feed I consisting of hard wax and soft wax a warm solvent II is added and the feedstock-solvent mixture III passes the DPSE 172. In this apparatus the mixture is cooled by cooling agent IV. As a suitable cooling agent one can use filtrate from the primary filter. Upon cooling the mixture becomes slurry. The slurry V exits from the DPSE and goes into the second stage of crystallization within DPSC 174 as described in above cited book of Sequeira Avelino. The repulp filtrate VIII enters from the repulp filter into the DPSC 174. In the apparatuses 174 the said slurry is cooled by refrigerant, e.g. propane or ammonia. Here the crystallization process is completed and the resulting slurry VI goes to a primary filter 176, in which filtrate IV and primary wax cake VII are separated. The wax cake upon dilution by solvent passes to a repulp filter 178, in which repulp wax cake IX and repulp filtrate VIII are separated. The repulp filtrate VIII is returned to the system and is used for the slurry dilution before entering into DPSC 174.

The last stages of the process are designated by numerals 180 and 182. These stages are intended for the solvent recovery. During the stage 180 solvent is recovered by evaporation from the hard wax. During stage 182 solvent is recovered from soft wax by the same manner. The flow X of said two solvent returns into the system for the slack wax (feed) dilution and for the filters washing. The produced hard wax XII and soft wax XI are pumped from the deoiling unit to storage.

Referring to FIG. 9 it is shown a flow diagram of the separation method of the present invention implemented for the slack wax deoiling. The main steps thereof are in principle similar to those of the prior art process described above. The feed III passes through a main crystallization step, which is carried out in crystallization apparatus 184 of the present invention. In the crystallization apparatus the feedstock is cooled by a cooling agent, which is supplied to the hollow disks. For this purpose the same cooling agent as mentioned above is used.

After passing through the apparatus 184 the feedstock slurry V goes further to the final crystallization step (chilling by dilution), which is carried out in a conventional mixer 186. Here a supercooled solvent VIII chills the feedstock slurry. Thus, by virtue of a very efficient crystallization established in the crystallization apparatus 184 the final crystallization step does not require relatively complicated double-pipe chiller, nor does it require chilling by a refrigerant as in the above described prior art double-pipe scraped-surface chiller. Instead, a very simple mixer 186 can be employed, in which crystallization is completed upon diluting the slurry by a supercooled solvent. Mechanical mixing follows diluting. One can readily appreciate that employing of a simple mixer instead of rather complicated DPSC renders the whole system simpler, less expensive and more convenient in operation and in maintenance.

The further steps of the separation process are similar to those of the prior art and therefore the same numerals are used for the designation of the same elements in FIG. 9. It is seen, for example, that after completing the final crystallization step the feedstock-solvent slurry VI proceeds to filtration step, which can be carried out in a filter similar to the primary filter employed in the prior art separation process. However, the present invention advantageously renders also the filtration step more efficient, since the obtained wax crystals are large and homogeneous they do not clog the filter cloth and thus solvent more efficiently washes the cloth. Accordingly merely a primary filter unit is sufficient for completing the filtration step. The secondary washing of the wax cake is not needed.

One should appreciate that by virtue of this provision the system becomes even simpler, more economical and more convenient in operation and in maintenance.

Now with reference to non-limiting Example 1 and Table 1 it will be described how the present invention was implemented in practice for separating of petroleum based oils from wax.

### EXAMPLE 1

Deoiling of a slack wax feedstock was carried out in the crystallization apparatus of the present invention. The apparatus was of a pilot-size with feedstock capacity up to 18 kg per hour. The obtained results are presented below after they were scaled to an apparatus having feedstock capacity of 6000 kg per hour.

Mixture of Methyl Ethyl Ketone (MEK) with toluene was used as a solvent Temperature of filtration was kept +5° C.

Some parameters of the slack wax deoiling along with the obtained results in terms of feedstock oil content and produced hard wax quality, the process temperatures, filtration rate, filtration surface, hard wax yield and others are summarized in non-limiting Table 1 below. The data is compared with the conventional slack wax deoiling process using DPSE and DPSC with the same feedstock charge.

TABLE 1

| | Slack wax deoiling with: | |
|---|---|---|
| | crystallizer of | conventional |
| | present | crystallizers |
| Technological parameters | invention | (DPSE and DPSC) |
| Feedstock capacity, | 6000 | 6000 |
| kg/hour | | |
| Feedstock oil content, % wt | 8.3 | 8.3 |
| Solvent composition | 60/40 | 60/40 |
| MEK/Toluene, % vol. | | |
| Amount of crystallizers: | | |
| main step | 2 | 2 |
| final step | 1 (mixer) | 2 |
| Total crystallizer heat | 68 | 340 |
| exchange surface, m² | | |
| Feedstock temperature, ° C.: | 48/5 | 48/5 |
| inlet/outlet | | |
| Crystallization rate, ° C./hour | 15 | 120 |
| Amount of filters | | |
| primary | 2 | 3 |
| repulp | — | 2 |
| Total filtration surface, m² | 100 | 250 |
| Primary filtration rate | 60 | 40 |
| kg feedstock/m²hour | | |
| Hard wax output, kg/hour | 3700 | 3500 |
| Hard wax yield, % wt | 61.7 | 58.3 |
| Hard wax oil content, % wt | 0.5 | 0.5 |

From the Table 1 follows that apparatus of the invention is advantageous in comparison with the conventional crystallizers: there is no need in the second step of filtration (repulp filters), amount of crystallizers decreases twice, filtration rate is higher, the amount of filters is two time less and hard wax yield is higher.

It should be appreciated that the present invention is not limited to the above-described embodiments and that changes and one ordinarily skilled in the art can make modifications without deviation from the scope of the invention, as will be defined in the appended claims.

It should also be appreciated that the features disclosed in the foregoing description, and/or in the following claims, and/or in the accompanying drawings may, both separately and in any combination thereof, be material for realizing the present invention in diverse forms thereof.

When used in the following claims, the terms “comprise”, “include”, “have” and their conjugates mean “including but not limited to”.

We claim:

1. A method for separation of hydrocarbon oil and wax from a hydrocarbon waxy feedstock mixture comprising an oil component, a wax component and a solvent component, said method comprising cooling the feedstock by a cooling agent so as to induce crystallization of hard wax with subsequent separation of the crystallized hard wax from the feedstock, said method further comprising the steps of
providing a vessel defined by a tubular shell closed at its opposite ends by a front cover and by a rear cover, said shell having a forward port for introducing the feedstock mixture into the vessel and a rear port for evacuating the feedstock mixture in the form of slurry from the vessel, said vessel having a longitudinal central axis,
providing a plurality of hollow partitions dividing said vessel into plurality of compartments, each of said partitions having an inlet port for introducing the cooling agent thereinto and an outlet port for evacuating the cooling agent therefrom,
providing a plurality of branch pipes having bridging portions, which allow fluid communication between adjacent partitions such that the inlet port of a one hollow partition is in fluid communication with the outlet port of an adjacent hollow partition,
providing a flow of the feedstock mixture along the vessel in a direction from the forward port to the rear port,
providing a flow of the cooling agent through said plurality of hollow partitions in a counter-current direction with respect to said direction of the flow of the feedstock, said method further comprises orientation of said vessel horizontally and deployment of said branch pipes outside the vessel and at the same side from the longitudinal axis.

2. The method for separation as defined in claim 1, further comprising directing the flow of the feedstock in a serpentine fashion.

3. The method for separation as defined in claim 2, further comprising providing a shaft, which is extending along the longitudinal axis of the vessel between the front cover and the rear cover, said shaft passing through the hollow partitions and is rotatable by a drive.

4. The method for separation as defined in claim 3, further comprising providing a first clearance gap between the partitions and the shell and a second clearance gap between the partitions and the shaft, wherein the method comprises sealing the first clearance gap at a one partition and sealing the second clearance gap at an adjacent partition.

5. The method for separation as defined in claim 4, further comprising scraping of wax crystals from a surface of said partitions.

6. The method for separation as defined in claim 5, in which said scraping is carried out by a plurality of scraper arrangements secured on the shaft with possibility for rotating therewith.

7. The method for separation as defined in claim 6, further comprising rotating the scraper arrangements with peripheral linear velocity of 0.3-1.5 m/sec.

8. The method for separation as defined in claim 1, further comprising mixing of the feedstock mixture.

9. The method for separation as defined in claim 8, in which said mixing is carried out by at least one mixer secured on the shaft with possibility for rotating therewith.

10. The method for separation as defined in claim 9, further comprising mixing said feedstock proximate to the opposite ends of the vessel.

11. The method for separation as defined in claim 1, further comprising maintaining a relationship between cooling area and volume of the feedstock being cooled between adjacent partitions, said relationship satisfies an expression α=S/V, where S is the cooling area, V is the volume of feedstock mixture to be cooled and α is a parameter.

12. The method for separation as defined in claim 11, in which said parameter is 4-7.

13. The method for separation as defined in claim 11, in which said relationship is maintained in each of the said compartments.

14. The method for separation as defined in claim 1, in which said cooling agent is a solution of dewaxed oil and a solvent.

15. The method for separation as defined in claim 1, in which said crystallization is completed by mixing of the feedstock slurry with a supercooled solvent and said separation comprises filtration of the resulting mixture so as to obtain hard wax and soft wax.

16. An apparatus for separation of hydrocarbon oil and wax from a waxy feedstock containing an oil component, a wax component and a solvent component, said apparatus comprises
a chamber, in which the feedstock is cooled by a cooling agent to induce nucleation and growth of wax crystals, said chamber is configured as a vessel defined by a tubular shell closed at its opposite ends, said shell having a forward port for introducing the feedstock into the vessel and a rear port for evacuating the feedstock as a slurry from the vessel, said vessel having a longitudinal central axis,
a plurality of hollow partitions dividing the interior of the vessel into plurality of successive compartments, each of said hollow partitions having an inlet port for introduction the cooling agent thereinto and an outlet port for evacuating the cooling agent therefrom,
a plurality of branch pipes provided with bridging portions allowing fluid communication between the adjacent hollow partitions such that the inlet port of a one hollow partition is in fluid communication with the outlet port of an adjacent hollow partition, wherein said vessel is oriented horizontally and said branch pipes are located outside the vessel and at the same side from the longitudinal axis of the vessel.

17. The apparatus for separation as defined in claim 16, in which said vessel is configured as a cylinder and said hollow partitions are configured as disks.

18. The apparatus for separation as defined in claim 16, comprising a shaft extending longitudinally along the vessel from the rear cover to the front cover, said shaft extending through the partitions, said shaft being rotatable by a drive.

19. The apparatus for separation as defined in claim 17, in which a first clearance gap is provided between said disks and the shell and a second clearance gap is provided between said shaft and the disks.

20. The apparatus for separation as defined in claim 19, in which the first clearance gap is sealed at a one partition and the second clearance gap is sealed at an adjacent partition, the arrangement being such that the feedstock is allowed to flow in a serpentine fashion.

21. The apparatus for separation as defined in claim 17, further comprising at least one scraper arrangement suitable for scraping wax crystals growing on the disks, said scraper arrangement being secured on the shaft.

22. The apparatus for separation as defined in claim 21, in which said at least one scraper arrangement comprises a scraping blade situated in proximity to the disk and with possibility to float when it scrapes wax crystals growing thereon.

23. The apparatus for separation as defined in claim 16, further comprising at least one mixer suitable for mixing the waxy feedstock, said at least one mixer being secured on the shaft.

24. The apparatus for separation as defined in claim 23, which comprises two mixers, one of them being located proximate one end of the vessel and the second mixer being located proximate to the opposite end of the vessel.

25. The apparatus for separation as defined in claim 16, in which the inlet and outlet ports of the hollow partitions are provided with respective tubular portions, which are affixed to the shell and to the respective disks.

26. The apparatus for separation as defined in claim 25, in which said tubular portions are affixed to the shell and to the disks at locations, which are disposed at one side of the longitudinal axis of the shell, such that the disks are hanged on the shell.

27. The apparatus as defined in claim 16, in which said compartments are configured and dimensioned so as to main a relationship between cooling area and volume of the waxy feedstock within a compartment according to an expression α=S/V, where S is the cooling area, V is the volume of waxy feedstock to be cooled and α is a parameter.

28. The apparatus as defined in claim 27, in which said parameter is 4-7.

29. The apparatus as defined in claim 16, in which said feedstock originates from petroleum processing

30. The apparatus as defined in claim 14, in which said feedstock originates from food processing.
